(19) United States
(12) Patent Application Publication
(10) Pub. No.: US 2003/0150358 A1
(43) Pub. Date: Aug. 14, 2003

(54) Silicone weatherproofing compositions

(76) Inventors: Wen P. Liao, Clifton Park, NY (US); Timothy J. Fahrenkopf, Rensselaer, NY (US)

Correspondence Address: Kenneth S. Wheelock, at General Electric Company, One Plastics Avenue, Pittsfield, MA, 01201, US

(21) Appl. No.: 10/356,249

(22) Filed: Jan. 31, 2003

Related U.S. Application Data
(63) Continuation-in-part of application No. 09/887,964, filed on Jun. 22, 2001, now abandoned.
(60) Provisional application No. 60/213,632, filed on Jun. 23, 2000.

(51) Int. Cl. C08L 91/06; C09K 3/00

(52) U.S. Cl. 106/270; 106/271; 106/287.11; 524/188

(57) ABSTRACT

A weatherproofing composition containing an aqueous aminofunctional polyorganosiloxane emulsion, an aqueous organic polymer emulsion, a colorant and a particulate filler is useful for weatherproofing exterior wood and masonry surfaces.

### CROSS-REFERENCE TO RELATED APPLICATIONS

This application is a Continuation-in-Part application of U.S. Ser. No. 09/887,964, filed Jun. 22, 2001, which claims rights of priority from U.S. Provisional Patent Application Serial No. 60/213,632, filed Jun. 23, 2000.

### FIELD OF THE INVENTION

The present invention relates to silicone compositions, more particularly to silicone weatherproofing compositions.

### BRIEF DESCRIPTION OF THE RELATED ART

The use of organic coatings, such as, for example, paraffin waxes, polyurethanes and polyacrylates, and silicone polymer coatings, see for example, U.S. Pat. Nos. 4,846,886 and 4,931,319, to weatherproof exterior wood and masonry surfaces is known.

There is a continued interest in weatherproofing compositions that provide improved properties, such as for example, improved water repellency, improved resistance to UV radiation, improved durability.

### SUMMARY OF THE INVENTION

In a first aspect, the present invention relates to a silicone weatherproofing composition. In a first embodiment, the silicone weatherproofing composition of the present invention comprises a water-emulsifiable aminofunctional polyorganosiloxane and a particulate filler. In an alternative embodiment, the silicone weatherproofing composition of the present invention comprises a water-emulsifiable aminofunctional polyorganosiloxane, a water emulsifiable hydrophobic organic polymer and a colorant.

In a second aspect, the present invention relates to a method for protecting a substrate, comprising applying a silicone weatherproofing composition according to the present invention to at least a portion of at least one surface of the substrate.

In a third aspect, the present invention relates to a coated substrate, comprising a substrate and a layer of a silicone weatherproofing composition according to the present invention on at least a portion of at least one surface of the substrate.

In a preferred embodiment, the silicone weatherproofing composition of the present invention provides excellent water repellency, is resistant to degradation by UV radiation and provides a non-slippery finish to a substrate coated with the composition.

### DETAILED DESCRIPTION OF THE INVENTION

In a highly preferred embodiment, the silicone weatherproofing composition of the present invention comprises a water-emulsifiable aminofunctional polyorganosiloxane, a water emulsifiable hydrophobic organic polymer, a particulate filler and a colorant.

In a highly preferred embodiment, the weatherproofing composition of the present invention is an aqueous emulsion comprising, based on 100 parts by weight (“pbw”) solids, that is, excluding water, of the composition, from 1 pbw to 99.95 pbw, more preferably from 50 pbw to 95 pbw, even more preferably from 70 pbw to 90 pbw, of the water-emulsifiable aminofunctional polyorganosiloxane polymer, from 0 pbw to 90 pbw, more preferably from 1 pbw to 50 pbw, even more preferably from 5 pbw to 20 pbw, the water emulsifiable hydrophobic organic polymer, from 0 pbw to 20 pbw more preferably from 0.05 pbw to 10 pbw, even more preferably from 0.1 pbw to 5 pbw, of the particulate filler and from 0 pbw to 50 pbw, more preferably from 0.1 pbw to 25 pbw, even more preferably from 1 pbw to 10 pbw, of the colorant. In a preferred embodiment, the silicone weatherproofing composition further comprises water and the water-emulsifiable aminofunctional polyorganosiloxane and the water emulsifiable hydrophobic organic polymer are each in the form of an aqueous emulsion.

The water-emulsifiable aminofunctional organosiloxane of the composition of the present invention comprises one or more water-emulsifiable aminofunctional organosiloxane polymers, each comprising one or more structural units of the formula (I):

R¹ₐR²_{b}SiO_{(4-(a+b))/2} (I)

wherein:

each R¹ is independently hydroxyl or a monovalent hydrocarbon radical,

each R² is independently a monovalent amino-functional hydrocarbon radical,

0≦a≦2, and 1≦b≦3 subject to the limitation that (a+b)≦3.

As used herein “hydrocarbon radical” includes acyclic hydrocarbon radicals, alicyclic hydrocarbon radicals and aromatic hydrocarbon radicals.

As used herein, the terminology “acyclic hydrocarbon radical” means a straight chain or branched hydrocarbon radical, preferably containing from 1 to 20 carbon atoms per radical, which may be saturated or unsaturated and which may be optionally substituted or interrupted with one or more functional groups, such as, for example, carboxyl, cyano, hydroxy, halo and oxy. Suitable monovalent acyclic hydrocarbon radicals include, for example, alkyl, alkenyl, alkynyl, alkoxy, cyanoalkyl, carboxyalkyl, carboxamide, alkylamido and haloalkyl, such as, for example, methyl, ethyl, sec-butyl, tert-butyl, octyl, decyl, dodecyl, cetyl, stearyl, ethenyl, propenyl, butynyl, hydroxypropyl, cyanoethyl, carboxymethyl, chloromethyl and 3,3,3-fluoropropyl.

As used herein the term “alkyl” means a saturated straight or branched monovalent hydrocarbon radical. In a preferred embodiment, monovalent alkyl groups are selected from linear or branched alkyl groups containing from 1 to 12 carbons per group, such as, for example, methyl, ethyl, propyl, iso-propyl, n-butyl, iso-butyl, sec-butyl, tert-butyl, pentyl, hexyl, heptyl, decyl, dodecyl.

As used herein the term “alkenyl” means a monovalent straight or branched unsaturated hydrocarbon radical, preferably containing from 2 to 10 carbon atoms per radical, such as, for example, ethenyl, 2-propenyl, 3-butenyl, 5-hexenyl, 7-octenyl and ethenylphenyl.

As used herein, the terminology “alicyclic hydrocarbon radical” means a hydrocarbon radical containing one or more saturated hydrocarbon rings, preferably containing from 4 to 10 carbon atoms per ring, per radical which may optionally be substituted on one or more of the rings with one or more alkyl radicals, each preferably containing from 2 to 6 carbon atoms per group, halo radicals or other functional groups and which, in the case of an alicyclic hydrocarbon radical containing two or more rings, may be fused rings. Suitable monovalent alicyclic hydrocarbon radicals include, for example, cyclohexyl and cyclooctyl.

As used herein, the terminology “aromatic hydrocarbon radical” means a hydrocarbon radical containing one or more aromatic rings per radical, which may, optionally, be substituted on the aromatic rings with one or more alkyl radicals, each preferably containing from 2 to 6 carbon atoms per group, halo radicals or other functional groups and which, in the case of a aromatic hydrocarbon radical containing two or more rings, may be fused rings. Suitable monovalent aromatic hydrocarbon radicals include, for example, phenyl, tolyl, 2,4,6-trimethylphenyl, 1,2-isopropylmethylphenyl, 1-pentalenyl, naphthyl, anthryl.

In a preferred embodiment, each R¹ is independently hydroxy, alkyl, more preferably (C₁-C₆)alkyl or alkoxy, more preferably (C₁-C₆)alkoxy.

Suitable amino-functional hydrocarbon radicals are those monovalent hydrocarbon radicals having one or more primary, secondary or tertiary amino moieties per radical, including for example, aminoalkyl, diaminoalkyl, aminoalkyleneaminoalkyl and alkylaminoalkyl.

In a preferred embodiment, the each R² is independently a group according to the formula (II):

—R³—C—R⁴₃ (II)

wherein:

R³ is alkylene or —R⁵— (NR⁶—R⁷)_{c}—,

R⁴ is H, alkyl or —NR⁸₂, provided that, if R³ is alkylene, at least one R⁴ per radical is —NR⁸₂, each R⁵ and R⁷ is independently alkylene, cycloalkylene or arylene,

each R⁶ and R⁸ is independently H or alkyl, and

c is an integer of from 1 to 6.

Suitable amino-functional hydrocarbon radicals include, for example, aminopropyl and aminodimethyleneaminodimethylene. Suitable alkylene groups include, for example, methylene, dimethylene and trimethylene. Suitable cycloalkylene groups include, for example, cyclohexylene. Suitable arylene groups include, for example, phenylene, methylphenylene.

In a preferred embodiment, each R² is independently aminoalkyl, more preferably, aminopropyl or aminoalkyleneaminoalkyl, more preferably, N-aminoethylaminopropyl.

In a preferred embodiment, the aminofunctional organosiloxane of the composition of the present invention comprises one or more compounds according to the structural formula (III):

M_{d}M′ₑD_{f}D′_{g}TₕT′ᵢQⱼ (III)

wherein:

M is R⁹₃SiO_{1/2},

M′ is R¹⁰₂R¹¹SiO_{1/2},

D is R¹²₂SiO_{2/2},

D′ is R¹³R¹⁴SiO_{2/2},

T is R¹⁵SiO_{3/2},

T′ is R¹⁶SiO_{3/2},

Q is SiO_{4/2},

each R^{9,} R¹⁰, R¹², R¹³ and R¹⁵ is independently hydroxyl or a monovalent hydrocarbon radical,

each R¹¹, R¹⁴ and R¹⁶ is independently a monovalent amino-functional hydrocarbon radical, and

d, e, f, g, h, i and j are each integers of from 0 to 500, wherein (d+e+f+g+h+i+j)≧10, provided that at least one of e, g or i is not 0.

In a preferred embodiment, each R^{9,} R¹⁰, R¹², R¹³ and R¹⁵ is independently hydroxy, alkyl, more preferably (C₁-C₆)alkyl or alkoxy, more preferably (C₁-C₆)alkoxy. In a highly preferred embodiment, the water-emulsifiable amino-functional polyorganosiloxane polymer comprises, based on 100 structural units of the compound, from about 0.000001 to 5, more preferably from about 0.00001 to 0.1, structural units wherein one R¹ substituent is hydroxy or alkoxy.

In a preferred embodiment, the aminofunctional organosiloxane of the composition of the present invention comprises one or more compounds compound according to the structural formula (III), wherein: d, e, h, and j are each 0, each R¹² is independently (C₁-C₆)alkyl, more preferably, methyl, each R¹³ is independently hydroxy or (C₁-C₆)alkoxy, more preferably, hydroxy or methoxy, each R¹⁴ and R¹⁶ is independently aminoalkyl or aminoalkyleneaminoalkyl, more preferably, aminopropyl or N-aminoethylaminopropyl, and d, e, f, g, h, i and j are effective to provide a compound having a weight average molecular weight of from about 1,000 to about 500,000, more preferably, from about 10,000 to about 200,000.

Suitable aminofunctional polymers may be made, for example condensing an amino-functional alkoxy silane with a cationically emulsion polymerized polyorganosiloxane.

In a preferred embodiment, the silicone weatherproofing composition of the present invention comprises a water emulsifiable hydrophobic organic polymer. Water emulsifiable hydrophobic organic polymers are generically known. In a preferred embodiment, water emulsifiable hydrophobic organic polymer component of the silicone weatherproofing composition of the present invention comprises one or more of polyurethanes, polyacrylates, poly(styrene-butadiene)s, poly(styrene-acrylate)s, poly(styrene-melamine)s and paraffinic waxes. In a highly preferred embodiment, the water emulsifiable hydrophobic organic polymer comprises one or more water-emulsifiable polyurethane polymers. The water emulsifiable hydrophobic organic polymer promotes even distribution of the color components of the composition and imparts a water repellency to the cured coatings of the present invention.

Particulate fillers suitable as the particulate filler component of the composition of the present invention may be any water insoluble particulate filler, including, for example, fumed silica, surface-treated, for example, hydrophobicized, fumed silica, carbon black, titanium dioxide, ferric oxide, aluminum oxide, as well as other metal oxides, quartz, precipitated silica, hydrophobicized precipitated silica, calcium carbonate. In a preferred embodiment, the particulate filler comprises fumed silica or precipitated silica. In a preferred embodiment, the particulate filler has an average particle size of from about 10 nanometers (“nm”) to about 100 micrometers (“μm”), more preferably from about 50 nm to about 10 μm. It is preferred that the particulate fillers utilized in the composition of present invention be water dispersible.

In a preferred embodiment, the silicone weatherproofing composition of the present invention comprises, based on 100 pbw of the silicone weatherproofing composition, from 0.01 to 99 pbw, more preferably from 0.05 to 20 pbw, even more preferably from 0.1 to 5 pbw of the particulate filler.

Compounds suitable as the radiation absorbing compound of the composition of the present invention are generically known. In a preferred embodiment, the radiation absorbing compound is comprises one or more compounds selected from benzophenones, such as, for example, 2-hydroxybenzophenone, benzotriazoles, such as, for example, 2-hydroxyphenyl benzotriazole, poly(oxy-1,2-ethanediyl)-α-(3-(3-(2H-benzotriazol-2-yl)-5-(1,1-dimethylethyl)-4-hydroxyphenyl)-1-oxopropyl)-ω-hydroxy, poly(oxy-1,2-ethanediyl)-α-(3-(3-(2H-benzotriazol-2-yl)-5-(1,1-dimethylethyl)-4-hydroxyphenyl)-1-oxopropyl)-ω-(3-(3-(2H-benzotriazol-2-yl)-5-(1,1-dimethylethyl)-4-hydroxypheny)-1-oxopropoxy and 2-(3′,5′-bis(1,2-dimethylpropyl)-2′-hydroxyphenyl)-2H-benzotriazole, triazines, such as for example, phenyltriazine, and oxanilides, such as for example, oxalic anilide.

In a highly preferred embodiment, the silicone weatherproofing composition of the present invention comprises, based on 100 pbw of the silicone weatherproofing composition, from 0 to 10 pbw, more preferably from 0 to 3 pbw, even more preferably from 0 to 1 pbw, of one or more radiation absorbing compounds.

Compounds suitable as the hindered amine antioxidant of the composition of the present invention are generically known. In a preferred embodiment, the hindered amine antioxidant compound comprises one or more of bis(1,2,2,6,6-pentamethyl-4-piperidinyl)(3,5-di-tert-butyl-4-hydroxybenzyl)butylpropanedioate, bis(1,2,2,6,6-pentamethyl-4-piperidinylsebacate and decanoicacid, bis(2,2,6,6-teramethyl-4-piperidinyl)ester reaction products with tert butyl hydroperoxide and octane, the reaction product of 2,4-dichloro-6-(4-morpholinyl)-1,3,5-triazine with a polymer of 1,6-diamine, N,N′-bis(-2,2,4,6-tetramethyl-4-piperidenyl) hexane.

In a preferred embodiment, the silicone weatherproofing composition of the present invention comprises, based on 100 pbw of the silicone weatherproofing composition, from 0 to 10 pbw, more preferably from 0.01 to 5 pbw, even more preferably from 0.01 to 1 pbw, of one or more hindered amine antioxidant compounds.

In a preferred embodiment, the silicone weatherproofing composition of the present invention comprises one or more color components. Compounds suitable as the color components of the present invention include pigments, such as, for example, iron oxide, carbon black, titanium dioxide and organic dyes.

In a preferred embodiment, the silicone weatherproofing composition of the present invention comprises, based on 100 pbw of the silicone weatherproofing composition, from 0 to 50 pbw, more preferably from 0 to 25 pbw, even more preferably from 0 to 10 pbw, of one or more color compounds.

The silicone weatherproofing composition of the present invention may, optionally, further comprise other components, such as for example, other silicone polymers in addition to those described above, other organic polymers in addition to those described above, antifoam additives, antifreeze additives and surfactants.

A wide variety of substrates, that is, any solid substrate, may be coated with the weatherproofing composition of the present invention. Substrates particularly suitable as the substrate to be coated with the silicone weatherproofing composition of the present invention are those substrates, such as, for example, decks, fences, outdoor furniture, having exterior wood surfaces and those substrates, such as, for example, concrete patios, having exterior masonry surfaces such surfaces being comprised of concrete, brick or stone or mixtures thereof.

The silicone weatherproofing composition is applied to a substrate by any coating method suitable for aqueous coating compositions, such as, for example, spray, brush, roller, sponge applicator.

In a preferred embodiment, the silicone weatherproofing composition of the present invention is diluted with water and the diluted silicone weatherproofing composition is applied to a substrate by spraying.

### EXAMPLES 1-5

The silicone weatherproofing compositions of Examples 1-5 were each made by combining the ingredients set forth in TABLE I in the relative amounts (all amounts given in pbw) set forth below in TABLEs II and III according to the procedures set forth below.

The compositions of Examples 1-3 were made by combining ingredients described in Table I in the relative amounts listed in Table II, according to the following procedure. A “Part A” of the composition was made by charging the UV absorber, hindered amine and nonionic surfactants to a mixing vessel and mixing until homogeneous. A “Part B” was made as follows. The aminosilicone polymer emulsion, antifoam additive, propylene glycol and polyurethane emulsion were added to a second mixing vessel and mixed. Silica was the slowly added while mixing. Mixing was continued until the silica was completely dispersed. After the silica was completely dispersed, any pigments and dyes were slowly added and mixing was continued until the dyes and pigments were completely dissolved or dispersed. Parts A and Part B were then combined and mixed until homogeneous.

The compositions of Examples 4-5 were made by combining ingredients described in Table I in the relative amounts listed in Table II, according to the following procedure. The aminosilicone polymer emulsion, antifoam additive, and polyurethane emulsion were charged to a mixing vessel and mixed. Silica was slowly added while mixing. Mixing was continued until the silica was completely dispersed.

TABLE I

| | |
|---|---|
| UV Absorber | Tinuvin 1130, Ciba |
| Hindered Amine | Tinuvin 765, Ciba |
| Nonionic Surfactant I | Triton ™ X-114 ICI |
| Nonionic Surfactant II | Triton ™ X-305, ICI |
| Aminosilicone Polymer | Aqueous emulsion (about 37% copolymer |
| Emulsion | solids) of a copolymer made by |
| | condensation of a cationically emulsion |
| | polymerized polydimethysiloxane having a |
| | viscosity of about 1,000 centiStokes with |
| | aminoethylaminopropyltrimethoxysilane |
| Antifoam Additive | Aqueous silica/polydimethylsiloxane |
| | emulsion |
| Polyurethane Emulsion I | Bayhydrol 110, Bayer Corp. |
| Polyacrylate emulsion | Neocar 820, Union Carbide |
| Silica I | Hisil 135, PPG Industries |
| Silica II | Aerosil 200, Degusa |
| Black Pigment | R-3795 Carbon Black, Creanova |
| Black Iron Oxide Pigment | 90WD05 Black, Harwick |
| Red Pigment | R-3794 Red Oxide, Creanova |
| Yellow Pigment | R-3831 Yellow Oxide, Creanova |
| Black Dye | Orco Acid Blue Black B Ex Conc., Organic |
| | Dyestuffs |
| Red Dye | Orco Acid Phlox GR EX Conc., Organic |
| | Dyestuffs |
| Yellow Dye | Orco Nylosol Yellow 9GL 300%, Organic |
| | Dyestuffs |
| Color Blend | Blend containing 5 wt % black pigment, 65 |
| | wt % red pigment, 30 wt % yellow pigment |

TABLE II

| | Ex 1 | Ex 2 | Ex 3 | Ex 4 | Ex 5 |
|---|---|---|---|---|---|
| UV Absorber | 0.3 | 0.3 | 0.3 | — | — |
| Nonionic Surfactant I | 0.18 | 0.18 | 0.18 | | |
| Nonionic Surfactant II | 0.09 | 0.09 | 0.09 | — | — |
| Aminosilicone Polymer | 85.8 | 85.8 | 85.8 | 2357 | 2357 |
| Emulsion | | | | | |
| Antifoam Additive | 1.092 | 1.092 | 1.092 | 30 | 30 |
| Propylene Glycol | 0.9 | 0.9 | 0.9 | — | — |
| Polyurethane Emulsion I | 11.07 | 11.07 | 11.07 | 301 | 301 |
| Silica | 1.1 | 1.1 | 1.1 | 30 | 30 |
| Black Pigment | — | 0.329 | 0.33 | — | — |
| Iron Oxide Pigment | — | — | 1.6 | — | — |
| Red Pigment | — | 4.77 | 0.31 | — | — |
| Yellow Pigment | — | 2.19 | 4.69 | — | — |
| Black Dye | — | 0.055 | 0.055 | — | — |
| Red Dye | — | 0.22 | 0.22 | — | — |
| Yellow Dye | — | 0.11 | 0.11 | — | — |
| Δ_{coefficient of friction} | — | — | — | 27% | 15% |

The surface slipperiness imparted by the respective weatherproofing compositions was determined by measuring the coefficient of friction of non-treated and treated substrates. An increase of the coefficient of friction after treatment with a weatherproofing composition indicates that the treatment decreased the slipperiness of the substrate. A decrease in the coefficient of friction after treatment with a weatherproofing composition indicates that the treatment increased the slipperiness of the substrate.

Testing was performed as follows. A 6″ by 6″ pressure treated wood sample was cleaned with a clean cloth and the coefficient of friction was measured by sliding a weight across the substrate with an Instrumentors, Inc. Slip/Peel tester. The weight used in the measurement was wrapped with a 2.5″ by 6″ polyethylene-coated paper so that there is no direct contact between the weight and the substrate that is being measured. A fresh paper is used for every measurement. Each substrate was measured in two directions, that is, along the grain and against the grain of the substrate, and coefficient of friction was averaged.

After the coefficient of friction was determined, the substrate was cleaned with an aqueous of hydrogen peroxide and an alkylbenzene sulfonic acid and then rinsed with water. The surface water from the cleaned substrate was allowed to drain for 5 to 10 minutes. The substrates were then coated by spraying with a weatherproofing composition of Examples 4 or 5 that had been diluted 20:1 with water. The coated substrates were allowed to dry for 24 hours before the post-treatment coefficient of friction test was performed.

The change in coefficient of friction (Δ_{coefficient of friction}) was determined by Equation (I):

Δ_{coefficient of friction}=(COF_{treated}−COF_{untreated})/COF_{untreated} (I)

wherein COF_{treated} is the average coefficient of friction on the treated substrate and COF_{untreated} is the average coefficient of friction on the untreated substrate. Results are set forth above in TABLE II.

Substrates treated with compositions analogous to those of Examples 4 and 5, but lacking the silica particulate filler, exhibited a decrease in coefficient of friction, giving a Δ_{coefficient of friction} of about minus 20%.

### EXAMPLES 6-7

The compositions of Examples 6-7 were made by combining ingredients described in Table I in the relative amounts listed in Table III, according to the following procedure. The aminosilicone polymer emulsion, antifoam additive, and polyurethane or polyacrylate emulsion were charged to a mixing vessel and mixed. The silica and color blend were slowly added while mixing. Mixing was continued until the silica was completely dispersed and composition was homogeneous.

TABLE III

| | Ex 6 | Ex 7 |
|---|---|---|
| Aminosilicone Polymer | 162.2 | 162.2 |
| Emulsion | | |
| Antifoam Additive | 2 | 2 |
| Polyurethane Emulsion | 12.5 | — |
| II | | |
| Polyacrylate Emulsion | — | 12.5 |
| Silica II | 7.6 | 7.75 |
| Color Blend | 17.5 | 17.5 |

A pressure treated wood substrate was cleaned by scrubbing with an aqueous of hydrogen peroxide and an alkylbenzene sulfonic acid and then rinsed with water The silicone weatherproofing compositions of Examples 6 and 7 were each diluted to form a mixture of 1 part by volume silicone composition to 20 part by volume water. The mixtures were sprayed with a spraying bottle to the clean substrate, covering both the horizontal surface and vertical sides of the substrate. The coatings were allowed to dry for 24 hours.

The coating formed from the silicone composition of Example 6 exhibited a brown color that was uniformly spread throughout the horizontal surface and the sides of the substrate. The coating formed from the silicone composition of Example 7 exhibited a uniform color on the horizontal surface of the substrate but with very little color retained on the sides of the substrate and exhibited a distinct line separating the dark color on the horizontal surface and the light color on the vertical sides of the substrate.

1. An aqueous weatherproofing composition comprising:
(a) a water emulsifiable aminofunctional polyorganosiloxane; and
(b) a water emulsifiable hydrophobic organic polymer.

2. The composition of claim 1 further comprising a water insoluble particulate filler.

3. The composition of claim 2 wherein said water insoluble particulate filler is water dispersible.

4. The composition of claim 3 wherein said water emulsifiable amino functional polyorganosiloxane has the formula (I):
R¹ₐR²_{b}SiO_{(4-(a+b))/2} (I)
wherein:
each R¹ is independently hydroxyl or a monovalent hydrocarbon radical,
each R² is independently a monovalent amino-functional hydrocarbon radical, and 0≦a≦2, and 1≦b≦3, subject to the limitation that
(a+b)≦3.

5. The composition of claim 4 wherein said water emulsifiable hydrophobic organic polymer is selected from the group consisting of polyurethanes, polyacrylates, poly(styrene-butadiene)s, poly(styrene-acrylate)s, poly(styrene-melamine)s and paraffinic waxes.

6. The composition of claim 5 wherein said water dispersible water insoluble particulate filler is silica.

7. The composition of claim 6 further comprising non-ionic surfactants.

8. The composition of claim 7 further comprising a radiation absorbing compound.

9. An aqueous weatherproofing composition comprising:
(a) a water emulsifiable aminofunctional polyorganosiloxane having the formula (I):
R¹ₐR²_{b}SiO_{(4-(a+b))/2} (I)
wherein:
(i) each R¹ is independently hydroxyl or a monovalent hydrocarbon radical,
(ii) each R² is independently a monovalent amino-functional hydrocarbon radical, and 0≦a≦2, and 1≦b≦3 subject to the limitation that (a+b)≦3;
(b) a water emulsifiable hydrophobic organic polymer selected from the group consisting of polyurethanes, polyacrylates, poly(styrene-butadiene)s, poly(styrene-acrylate)s, poly(styrene-melamine)s and paraffinic waxes; and
(c) a water insoluble particulate filler wherein said filler is water dispersible.

10. A method of weatherproofing exterior surfaces comprising treating the exterior surfaces with an aqueous weatherproofing composition said composition comprising:
(a) a water emulsifiable aminofunctional polyorganosiloxane; and
(b) a water emulsifiable hydrophobic organic polymer.

11. The method of claim 10 wherein said composition further comprises a water insoluble particulate filler.

12. The method of claim 10 wherein said water emulsifiable aminofunctional polyorganosiloxane has the formula (I):
R¹ₐR²_{b}SiO_{(4-(a+b))/2} (I)
wherein:
each R¹ is independently hydroxyl or a monovalent hydrocarbon radical,
each R² is independently a monovalent amino-functional hydrocarbon radical, and 0≦a≦2, and 1≦b≦3 subject to the limitation that (a+b)≦3.

13. The method of claim 12 wherein said water emulsifiable hydrophobic organic polymer is selected from the group consisting of polyurethanes, polyacrylates, poly(styrene-butadiene)s, poly(styrene-acrylate)s, poly(styrene-melamine)s and paraffinic waxes.

14. A weatherproofed substrate wherein said substrate has been weatherproofed by treating with an aqueous weatherproofing composition said composition comprising:
(a) a water emulsifiable aminofunctional polyorganosiloxane; and
(b) a water emulsifiable hydrophobic organic polymer.

15. The weatherproofed substrate of claim 14 wherein said composition further comprises a water insoluble particulate filler.

16. The weatherproofed substrate of claim 15 wherein said water emulsifiable aminofunctional polyorganosiloxane has the formula (I):
R¹ₐR²_{b}SiO_{(4-(a+b))/2} (I)
wherein:
each R¹ is independently hydroxyl or a monovalent hydrocarbon radical,
each R² is independently a monovalent amino-functional hydrocarbon radical, and 0≦a≦2, and 1≦b≦3 subject to the limitation that (a+b)≦3.

17. The weatherproofed substrate of claim 16 wherein said water emulsifiable hydrophobic organic polymer is selected from the group consisting of polyurethanes, polyacrylates, poly(styrene-butadiene)s, poly(styrene-acrylate)s, poly(styrene-melamine)s and paraffinic waxes.

18. The substrate of claim 14 wherein said substrate is selected from the group consisting of wood, concrete, brick, stone and mixtures thereof.
